(19) United States
(12) Patent Application Publication
(10) Pub. No.: US 2017/0342976 A1
(43) Pub. Date: Nov. 30, 2017

(54) POSITIVE DISPLACEMENT PUMP VALVE SEAL

(71) Applicant: SCHLUMBERGER TECHNOLOGY CORPORATION, Sugar Land, TX (US)

(72) Inventors: Bhavish Nagaraja Reddy, Sugar Land, TX (US); Jahir Pabon, Newton, MA (US); Garud Bindiganavale Sridhar, Sugar Land, TX (US)

(21) Appl. No.: 15/165,962

(22) Filed: May 26, 2016

(51) Int. Cl. F04B 53/10; F16K 1/42; F04B 19/22; E21B 43/26; E21B 43/267

(52) U.S. Cl. CPC F04B 53/1087; F16K 1/42; F04B 19/22; E21B 43/267; E21B 43/26

(57) ABSTRACT

A valve and seal arrangement for extended life in a positive displacement pump. The arrangement may take on different configurations. The seal may be secured within a shielding sidewall of a valve head for isolation from differential pressure during striking of the valve head at a valve seat. Additionally, the seal itself may include an axial tail for sealing off the fluid chamber below and defined by the seat prior to the striking of the valve head at the seat. Further, a horizontal flange defining a clearance of no more than about a layer of an abrasive constituent of a slurry being pumped may be utilized. That is, as opposed to, or in addition to, sealing in advance of striking, flow may be reduced to no more than a constituent layer thickness in advance of the striking. Other similarly advantageous architectural valve features may also be employed.

### BACKGROUND

Exploring, drilling and completing hydrocarbon and other wells are generally complicated, time consuming and ultimately very expensive endeavors. As a result, oilfield efforts are often largely focused on techniques for maximizing recovery from each and every well. Whether the focus is on drilling, unique architecture, or step by step interventions directed at well fracturing, the techniques have become quite developed over the years. One such operation at the well site directed at enhancing hydrocarbon recovery from the well is referred to as a stimulation application. Generally, in conjunction with fracturing, a stimulation application is one in which a large amount of proppant, often a type of sand, is directed downhole at high pressure along with large volumes of water. So, for example, downhole well perforations into a formation adjacent the well which have been formed by fracturing may be further opened and/or reinforced for sake of recovery therefrom.

For effectiveness, the slurry of proppant and water that is utilized during stimulation is often supplied downhole at considerable rates and pressures. For example, it would not be uncommon for the slurry to be pumped at more than 60-100 barrels per minute (BPM) at pressures exceeding 10,000 PSI. Thus, in order to ensure that a sufficient volume, rate and pressure of the slurry is delivered during the stimulation application, a host of positive displacement pumps are often positioned at the oilfield for sake of driving the stimulation application. Specifically, each one of several pumps may be fluidly linked to a manifold which coordinates the overall delivery of the slurry fluid downhole.

Each of the noted positive displacement pumps may include a plunger driven by a crankshaft toward and away from a chamber in order to dramatically effect a high or low pressure on the chamber. This makes it a good choice for high pressure applications. Indeed, even outside of stimulation operations, where fluid pressure exceeding a few thousand pounds per square inch (PSI) is to be generated, a positive displacement pump is generally employed. In the case of stimulation operations specifically though, this manner of operation is used to effectively direct an abrasive containing fluid through a well to release oil and gas from rock pores for extraction.

As is often the case with large systems and industrial equipment, regular monitoring and maintenance of positive displacement pumps may be sought to help ensure uptime and increase efficiency. In the case of hydraulic fracturing applications, a pump may be employed at a well and operated for an extended period of time, such as six to twelve hours per day for more than a week. Over this time, the pump may be susceptible to wearing components such as the development of internal valve leaks. This is particularly of concern at conformable valve inserts used at the interface of the valve and valve seat. These “inserts” are elastomeric seals that are located in relatively challenging internal pump locations and must be manually inspected. Generally, due to the minimal costs involved, regardless of whether the inspection reveals defects, the seals will be replaced once the scheduled inspection has begun.

However, given that seal replacement will be required several times over the course of standard operations which generally last for a week or two at any given wellsite, there remains a significant cost involved. Specifically, added labor and manpower dedicated to repeatedly rotating pumps from use to inspection and back into operation is required at all times. Additionally, since pumps are constantly being rotated on and off-line for sake of inspection and seal replacement, there are several additional pumps sitting at each wellsite waiting to be called into service. Thus, the cost of ownership at each wellsite is dramatically increased. By way of specific example, it would not be uncommon to employ about 10 pumps at a wellsite for stimulation with an extra two or three pumps not in use but waiting to be rotated in as needed. Given that each pump is generally in excess of about 1 million dollars in today's numbers, this means that at any given point in time, an extra 3 million dollars or more in equipment expenses are being dedicated to equipment that is not being used. This is a considerable amount of expense being added to an already very costly endeavor.

Of course, while these measures are expensive, they are far less than the cost of failing to take such precautions. For example, the conformable nature of the seal means that it is susceptible to bulging related damage and abrasive cracking from the pumped fluid. Thus, if not regularly replaced, the seal may fail to seal, leading to pump failure which can have a cascading effect due to strain on other pumps of the system. Ultimately, this may result in the catastrophic shutdown of all wellsite operations and the need to repair ten or more pumps simultaneously.

Efforts have been undertaken to acoustically, or otherwise, monitor valve performance in real time in an effort to reduce the number of seal replacements required during ongoing operations. However, as a practical matter, there remains no high performing seal capable of reliably withstanding standard ongoing wellsite operations of a week or more. Thus, at present the need to maintain added technical labor and high dollar pumps in reserve remains even with such monitoring in place.

### SUMMARY

Valve embodiments for positive displacement pumps are detailed herein. A valve may include a stationary valve seat adjacent a chamber for pumping fluid therethrough, A reciprocating valve head opposite the chamber may be provided for intermittently engaging the seat with a metal strike face thereof as well as with an elastomeric seal on the head for engaging the seat, the seal engaging the seat to seal the fluid in the chamber. In an embodiment, a horizontal flange of the valve head may be provided to partially retain the seal at a lower surface thereof. A vertical flange of the strike face of the valve head is also provided to retain the seal at an outer diameter thereof. In another embodiment, the seal and the seat are configured to physically interface in a non-linear manner while engaging. Additionally, in another embodiment, the valve seat may be equipped with multiple axes different from one another such that multiple striking regions are provided between the seat and the valve and/or seal.

### BRIEF DESCRIPTION OF THE DRAWINGS

FIG. 1 is a cross-sectional side view of a positive displacement pump employing upper and lower valves outfitted with an embodiment of a seal having an axial tail portion.

FIG. 2A is an enlarged side view of the upper valve of FIG. 1 with the seal thereof apparent at the underside of a valve head.

FIG. 2B is a cross-sectional view of the upper valve taken from 2-2 of FIG. 2A revealing the extension of the tail into the fluid chamber below the valve during physical interface with a seat of the pump.

FIG. 3 is a cross-sectional side view of an embodiment of the valve employing a horizontal flange to retain the seal at the seat above the chamber during physical interface.

FIG. 4 is a cross-sectional side view of an embodiment of the valve employing a seal with a non-linear outer surface for physically interfacing the seat.

FIG. 5A is a cross-sectional side view of an embodiment of the valve employing a seal with axially independent horizontal strike face for physically interfacing the seat apart from a metal strike face of the valve for also interfacing the seat.

FIG. 5B is a cross-sectional side view of an embodiment of the valve employing a seal with axially independent diagonally tapered strike face for interfacing the seat apart from a metal strike face of the valve for also interfacing the seat.

FIG. 6 is an overview depiction of an oilfield employing the pump of FIG. 1 in oilfield operations with an embodiment of a valve and seal of FIGS. 2-5A and 5B therein.

### DETAILED DESCRIPTION

In the following description, numerous details are set forth to provide an understanding of the present disclosure. However, it will be understood by those skilled in the art that the embodiments described may be practiced without these particular details. Further, numerous variations or modifications may be employed which remain contemplated by the embodiments as specifically described.

Embodiments are described with reference to certain embodiments of oilfield operations. Specifically, stimulation operations involving fracturing of a well are detailed herein. However, other types of oilfield operations may benefit from the valve and seal embodiments detailed herein. For example, any number of pump applications may be run where valve life and effectiveness are extended and enhanced by use of such valve and/or seal embodiments. This may include cementing and a host of other operations in which pumps are utilized to perform applications in a well. Indeed, so long as a seal and/or valve architecture embodiment is employed in such operations as detailed herein, appreciable benefit may be realized. Additionally, the term “seal” is employed herein for elastomeric seals that are utilized with reciprocating valve heads for repeatedly striking valve seats over the course of pumping operations. This term is meant to encompass related terminology that is sometimes interchangeably utilized, such as “valve insert”, “element” or other variations.

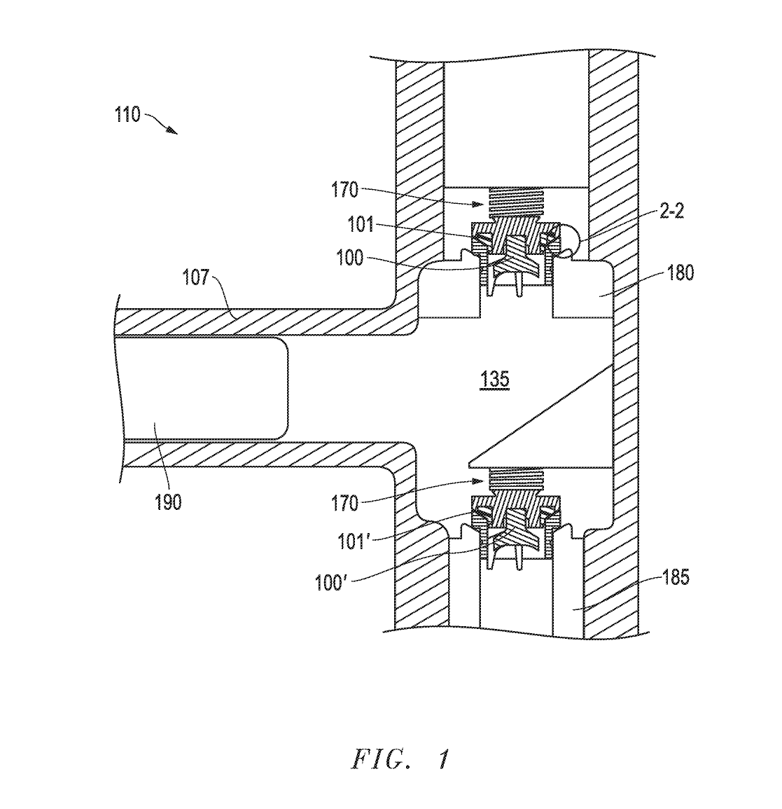

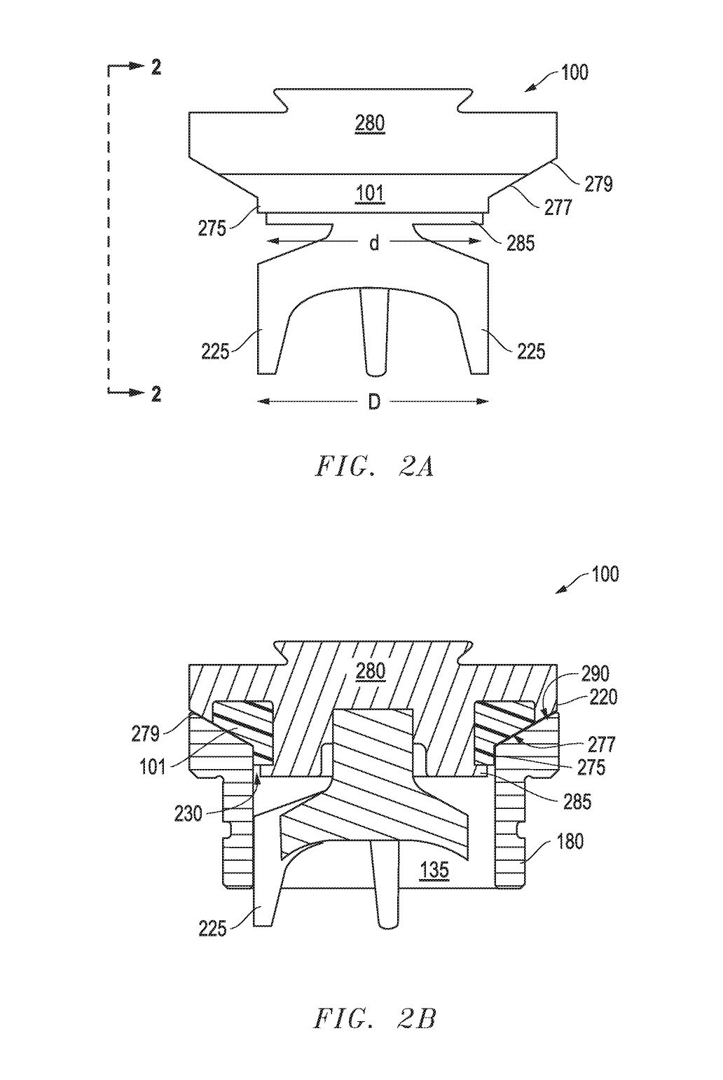

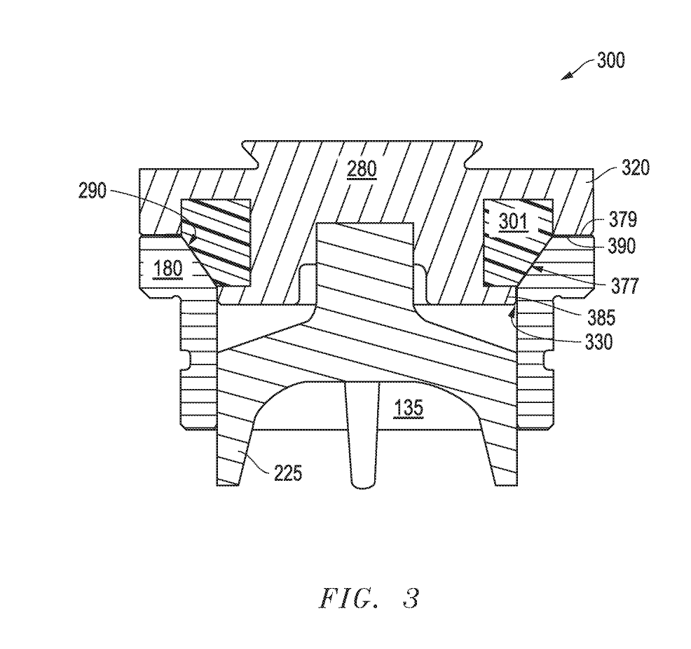

Referring specifically now to FIG. 1, a cross-sectional side view of a positive displacement pump 110 employing upper 100 and lower 100′ valves is shown. Each valve 100, 100′ is outfitted with an embodiment of a seal 101, 101′ having an axial tail portion 275 as highlighted and detailed further in FIGS. 2A and 2B below. However, in other embodiments, other architectural configurations of valve 300, 400, 500 and seal 301, 401, 501 (or 502) combinations may be employed (see FIGS. 3-5A and 5B). Regardless, the combinations may be employed to substantially extend seal life during regular pump use at an oilfield during conventional operations such as stimulation and others.

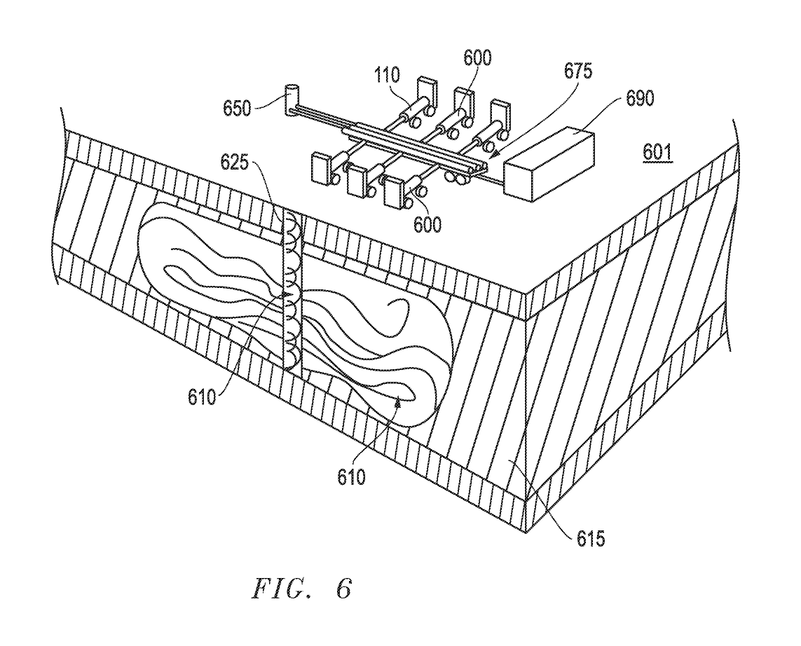

As alluded to above, regular use of a pump 110 in oilfield operations means the repeated reciprocation of valves 100, 100′ against a seat 180, 185 for an extended duration, perhaps weeks at a time. This takes place as a plunger 190 reciprocates within a housing 107 toward and away from a chamber 135. In this manner, the plunger 190 effects high and low pressures on the chamber 135. For example, as the plunger 190 is thrust toward the chamber 135, the pressure within the chamber 135 is increased. At some point, the pressure increase will be enough to effect an opening of the upper discharge valve 100 to allow release of fluid and pressure from within the chamber 135. The amount of pressure required to open the valve 100 as described may be determined by a discharge mechanism 170 such as a spring which keeps the discharge valve 100 in a closed position (as shown) until the requisite pressure is achieved in the chamber 135. In an embodiment where the pump 110 is employed with others for stimulation at an oilfield, 601, pressures in excess of 2,000-10,000 PSI may be achieved in this manner (see FIG. 6).

Continuing with reference to FIG. 1, the plunger 190 also effects a low pressure on the chamber 135 as it retreats away from the chamber 135, thus decreasing the pressure therein. As this occurs, the discharge valve 100 will strike closed against the upper discharge valve seat 180 as is depicted in FIG. 1. This movement of the plunger 190 away from the chamber 135 will initially result in a sealing off of the chamber 135. However, as the plunger 190 continues to move away from the chamber 135, the pressure therein will continue to drop, and eventually a low or negative differential pressure will be achieved therein. Eventually, as depicted in FIG. 1, the pressure decrease will be enough to effect an opening of the lower intake valve 100′ for the uptake of fluid into the chamber 135. Again, the amount of negative or reduced pressure required to open the valve 100′ may be predetermined by an intake mechanism 175 such as a spring. Of course, upon return of the plunger 190 toward the chamber 135, the lower valve 100′ will again strike closed against the lower valve seat 185 with a seal achieved by the lower seal 101′.

The repeated striking of the valves 100, 100′ and seals 101, 101′ against the metal seats 180, 185, subjects, particularly the elastomeric seals 101, 101′, to a significant amount of potentially wearing conditions. However, as alluded to above, the unique valve 100, 100′ and seal 101, 101′ architectures employed herein may be utilized to substantially delay or eliminate the need for seal replacement during typical oilfield pumping operations.

Referring now to FIG. 2A, an enlarged side view of the upper valve 100 of FIG. 1 is shown with the elastomeric seal 101 thereof apparent at the underside of a valve head 280. In this depiction, it is apparent that the axial tail portion 275 of the seal 101 extends axially below the elastomeric strike face 277 of the seal. As indicated above, this means that this portion 275 of the seal 101 is configured to reach into communication with the chamber 135 even once the strike face 277 contacts the valve seat 180 and seals off the chamber 135 periodically as described above (see FIG. 1).

The valve 100 includes a leg portion 225 for un-obstructingly reaching into the chamber 135 of FIG. 1 and a valve head 280 for accommodating the seal 101 and including its own strike face 279 for also periodically contacting the valve seat 180 during sealing as described above. As shown, the valve head 280 includes a receiving support 285. In the embodiment shown, this support 285 provides structural support for the axial tail portion 275 as both reach into the chamber 135 as described above, even upon achieving a seal thereof (again, see FIG. 1). Thus, the underlying diameter (d) of the receiving support 285 is somewhat less than the diameter (D) of the axial tail portion 275. Indeed, as detailed below, the diameter (D) is large enough to allow the tail portion 275 to form a periodic axial seal within the chamber 135 as defined by the body of the seat 180. As a result, wear on the seal 101 may be substantially reduced, thereby extending the life of the seal 101.

Referring now to FIG. 2B, a cross-sectional view of the upper valve 100 taken from 2-2 of FIG. 2A is shown. In this depiction, the extension of the noted tail portion 275 sealingly into the fluid chamber 135 below the valve 100 during physical interface with a seat 180 is apparent. Keeping in mind that wear on the seal 101 is primarily introduced through the repeated elastomer to metal contact between the strike face 277 of the seal 101 and the face 290 of the seat 180, it is notable that the axial tail 275 is located at a different interfacing site with the seat 180. That is, the elastomeric seal face 277 may directly strike the metal seat 180 repeatedly at a frequency of perhaps 2-6 Hz. Further, any given strike may be at substantial force and, in the case of a more conventional seal, perhaps with intermittent proppant or other abrasive slurry constituents trapped at the interface during the strike, rendering an increased rate of cracking and wear.

However, in the embodiment depicted, the seal 101 includes an axial tail portion 275 that, during reciprocation of the valve 100, is configured to extend into and seal off the chamber 135 a moment prior to the striking of the seal face 277 with the face 290 of the seat 180. As a result, the striking of the seal face 277 against the seat face 290 occurs at a time when a substantial amount of slurry abrasive is unlikely to be located at this striking interface. That is, the flow of fluid slurry from within the chamber 135 and across this interface is momentarily disrupted by the sealing off of the chamber 135 in advance of the noted striking. As the chamber 135 is sealed by the axial tail 275, the inertia of the fluid that has already escaped the chamber 135 may continue to take it away from the seat 180 and out of the pump 110 for downstream use (see FIG. 1). This means that at the moment the striking of the seal face 277, the slurry is either momentarily trapped in the chamber 135 or has largely moved on beyond the interface of the seat 180 and seal 101.

As a practical matter, use of a seal 101 and valve 100 as described above, would not notably impede flow of the pumped fluid. For example, the axial tail portion 275 of the seal 101 may extend no more than about 0.25 inches. Thus, considering the typical rate of reciprocation for the plunger 190 and valve 100 components, this may translate into a delay between chamber sealing and striking of the valve 100 at the seat 180 of less than about 0.3 seconds. Therefore, the introduction of a brief sealing-based interruption by the axial tail 275 just prior to the seal 277 and head face 279 striking the seat face 290 is of no significant impact to the effectiveness of the pumping application.

Continuing with reference to FIG. 2B, with added reference to FIG. 1, it is also apparent that the seal 101 is largely contained or retained within the head 280 of the valve 100 in a shielded manner. For example, the described axial tail portion 275 of the seal 101 is not entirely exposed at the lower end thereof. Rather, a receiving support 285 is shown extending laterally from the head 180 and below the tail 275. While the support 285 does not reach completely along the underside of the tail 275 or contact the sidewall of the chamber 135 it does provide substantial support to the seal 101.

Further, and perhaps more notably, the head 280 is also equipped with a shielding sidewall 220 which terminates at the head face 279 which ultimately strikes the seat face 290 as noted above. However, this feature also serves to shield the seal 101 from the comparatively higher pressures at the opposite side of the valve 100 from the chamber 135. That is, over the course of operations, the pump 110 is generally utilized to acquire and drive up pressures of an application fluid such as a fracturing slurry as alluded to above. This means that as a general rule, the fluid within the chamber 135 will be below that of the much higher pressures that are generated, for example, by multiple pumps and found in common lines outside of the depicted discharge valve 100. Nevertheless, the elastomeric seal 101, which may otherwise be susceptible to a degree of wear upon regular exposure to several thousand PSI of differential pressures, is shielded from such repeated exposures by the noted sidewall 220. Indeed, given the elastomeric nature of the seal 101, the entirety is shielded from the effects of such exposures, and not just the seal surface in contact with the sidewall 220. In other words, unlike in a conventional arrangement where the effects of such high pressure exposure may fluidly migrate across the body of the seal 101, the entire seal 101 of the depicted embodiments is shielded by the sidewall 220, particularly at the moment of striking.

In an embodiment, the valve 100 and seal 101 may be of a different architecture such that the tail 275 is located at the upper end of the seal 101 and of a larger diameter, commensurate with the head 280. In this embodiment, a vertical sealing may take place at this higher, discharge, side of the valve 100 with slurry constituents largely trapped therebelow, at the chamber side of the valve 100 during striking.

Referring now to FIG. 3, a cross-sectional side view of an embodiment of a valve 300 is shown employing a horizontal flange 385 to retain a seal 301 at the seat 180 above the chamber 135 during the depicted striking physical interface. That is, unlike the embodiments detailed above, as the seal face 377 strikes the seat face 290, the seal 301 itself does not include an axial portion for extending into or sealing off the chamber 135 in advance of the striking. Thus, instead of protecting the seal 301 from trapping slurry constituents at the interface during striking by interrupting slurry flow with an axial tail 275 as shown in FIGS. 2A and 2B, an alternative technique is utilized.

In the embodiment of FIG. 3, the noted horizontal flange 385 is of dimensions that are based on the diameter of the chamber 135 as defined by the seat 180. More specifically, the flange 385 is configured to leave a predetermined clearance 330 that is tailored to the particular slurry that is being pumped through the chamber 135. So, for example, a given slurry that is to be pumped through the chamber 135 may have a proppant that is between about 0.015 and 0.020 inches in layer thickness. Where this is the case, the clearance 330 may be no more than about 0.020 inches. Of course, in typical operations, a layer of proppant may be anywhere from about 0.006 to about 0.030 inches (e.g. 100 to 20 mesh). Regardless, so long as the clearance 330 is tailored in light of the proppant (or other abrasive slurry constituent dimensions), appreciable benefit may be attained.

By way of contrast, the clearance 230 of FIG. 2B is a side result of the focus on providing sufficient structural support to the seal 101 by the receiving support 285 without unintentionally contacting chamber sidewalls. However, the slurry tailored clearance 330 of FIG. 3 is not only a result of the flange 385 providing seal support but more notably particularly tailored to substantially allow no more than a single layer of proppant to occupy the clearance 330. This means that as the valve 300 travels downward, the flange 385 will become positioned adjacent the sidewall of the seat 180 that defines the chamber 135. At this moment, only the minimal clearance 330 will be available to the flow of slurry, even prior to the striking closed of the valve 300. Thus, in the embodiment shown, in the subsequent moment, as the seal 377 and valve head 379 faces contact the seat faces 290, 390, the presence of slurry, and in particular, abrasive particles thereof has already been minimized due to the minimal clearance 330 provided by the flange 385. That is, rather than serving a sealing function as with the axial tail 275 of FIGS. 2A and 2B, the flange 375 serves a function of minimizing the presence of potentially harmful proppant and other abrasives to no more than a layer's worth during striking closed of the valve 300. As a result, similar benefit may be obtained, however, without the periodic resultant interruption of slurry flow as found in the embodiments of FIGS. 2A and 2B.

Again, the valve 300 includes a head 280 with an architecture for shielding the seal 301 from the pressurized slurry that is being pumped. Specifically, in addition to being supported by a flange 385 that traverses almost the entirety of the underside of the seal 301, the shielding sidewall 320 of the head 280 isolates the seal 301 from the high pressure, discharge, side of the valve 300. Further, as alluded to above, in the embodiment shown, the valve head's strike face 379 is on a different axis than that of the seal 377. For example, the horizontal metal to metal contact between this face 379 and that of the seat 390 may provide a greater degree of isolation to the seal 301 at the moment the valve 300 strikes closed as shown.

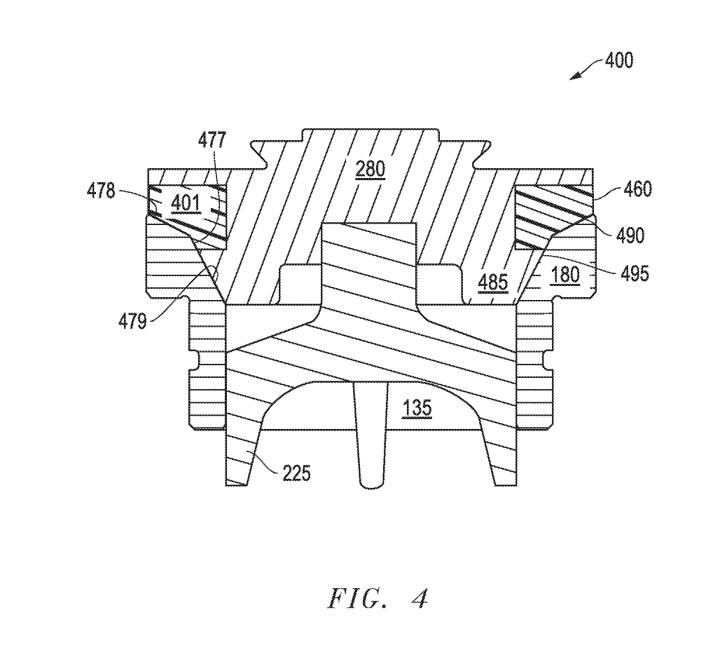

Referring now to FIG. 4, a cross-sectional side view of an embodiment of a valve 400 is shown which addresses seal exposure to differential pressure at the discharge side of the valve 400 during striking. For example, as depicted, the seal 401 may even remain exposed to such differential pressures at the outer diameter surface 460 thereof. However, the face 477 (478) of the seal 401 is located entirely to the discharge side of the valve head 280 whereas the strike face 479 of the head 280 is provided by a head base 485 and entirely at the chamber side of the valve 400.

The reversal of orientation for the strike faces 477 (478) and 479, means that during valve reciprocation, the metal base 485 will be the first to contact the seat 180 (with 479 striking 495). As a result, this means that similar to other embodiments above, the slurry being pumped through the chamber 135 is substantially cut off from exposure to the seal 401 just prior to the completed strike of the valve 400 at the seat 180. Once more, the substantial base 485 provides increased metal to metal contact during strike. Further, the substantial character of the base 485, combined with the occluded chamber 135 at the moment the seal 401 reaches the valve seat 180, provides substantial reinforcement to the seal 401 at the moment the seal 401 might otherwise be susceptible to differential pressures at the discharge side of the valve 400 as detailed above.

Continuing with reference to FIG. 4, the seal 401 is also equipped with multiple strike faces 477 and 478 which are angled differently from one another (i.e. at different axes). Similarly, the seat 180 is equipped with multiple faces 490, 495 of differing angles (i.e. axes) for matching the faces 477 and 478 as the valve 400 strikes the valve seat 180. The resultant non-linear striking engagement which traverses the seal 401 may provide the added advantage of increasing the surface area of the seal 401 and thereby reducing cyclic stresses on the seal 401.

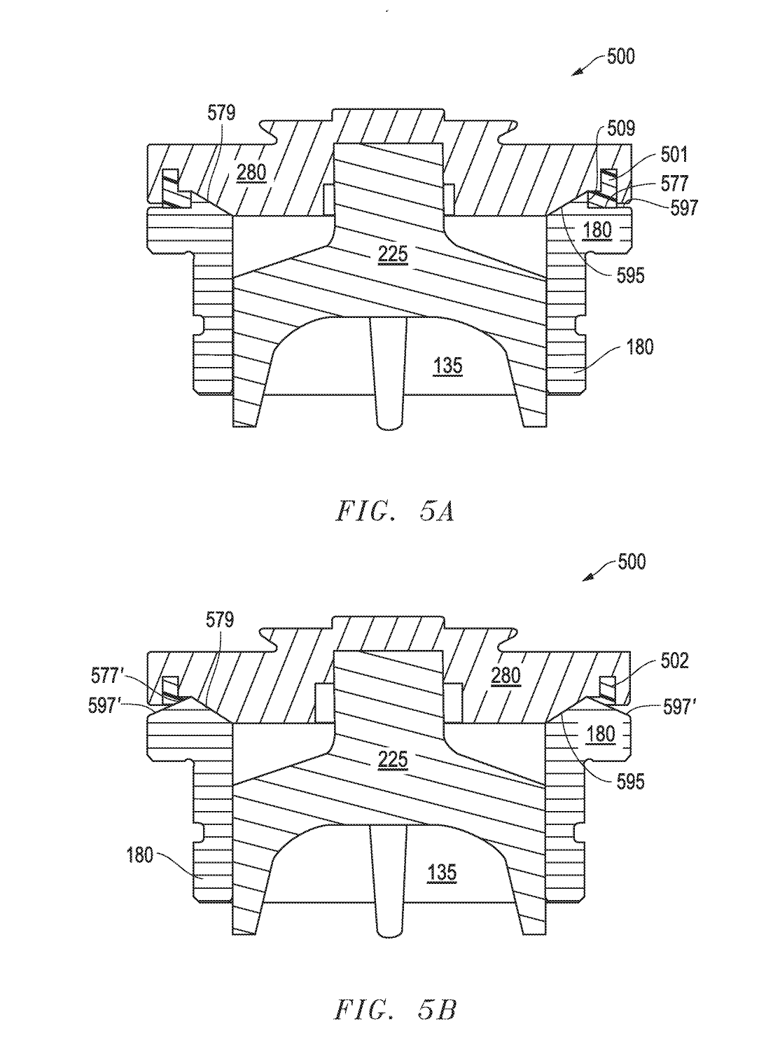

Referring now to FIG. 5A, a cross-sectional side view of an embodiment of a valve 500 is shown employing a seal 501 with axially independent and substantially horizontal strike face 577. That is, this face 577 is not just at a different axis from that of the strike face 579 of the valve head 280 but rather, entirely discontinuous from it. For example, as depicted, this face 577 physically interfaces the seat 180 at a horizontal surface 597 whereas the strike face 579 of the head 280 is at another non-horizontal incline axis.

Again, the seal 501 is located at the more unique discharge side of the valve 500. However, the metal to metal interfacing of the head 280 with the seat 180 at its face 595 begins to take place before the seal 501 strikes fully closed at the surface 597. Thus, once again, a degree of protection from slurry constituents is provided to the seal 501 just prior to the strike face 577 of the seal reaching the seat surface 597. However, in this embodiment, the seal 501 is of an architecture that sealing begins to take place at a substantially vertical side 509 of the seal 501 before the impact of the strike is completed. That is, actual sealing by the seal 501 begins in a vertical location (509) that is not subjected to the full impact of the seal 501 striking the surface 597. As a result, any proppant or other abrasive at vertical side 509 is never subjected to being forcibly driven into or damaging the seal 501 to the extent possible if the abrasive were located at the substantially horizontal surface 597. However, as indicated, the likelihood of the abrasive being located 597 at this surface 597 is minimized given that sealing off of the slurry flow has already begun at the vertical side 509 of the seal 501.

As with the embodiment of FIG. 5B detailed below, the seal 501 of FIG. 5A may be substantially retained and shielded within the valve head 280. However, in the embodiments shown, this may be more a matter of providing structural support. That is, exposure to the discharge side of the valve 500 during striking may be of less concern given the substantial metal to metal contact at an axis to the chamber side of the valve 500 (e.g. as 579 meets 595).

Referring now to FIG. 5B is a cross-sectional side view of an embodiment of the valve 500 is shown employing a seal 502 with axially independent diagonally tapered strike face 577′. Again, this strike face 577′ is configured to interface the seat 180 apart from a metal strike face 579 of the valve head 280 that also interfaces the seat 180. Specifically, the seal's strike face 577′ reaches an incline surface 597′ of the seat 180 as opposed to a horizontal surface 597 as shown in the embodiment of FIG. 5A. Nevertheless, the advantages of utilizing different axes for the metal to metal striking of the valve head 280 and the elastomeric striking of a seal 501 at a metal surface 597′ remains. Once more, in the embodiment of FIG. 5B, the utilization of tapered inclines may encourage the flow of slurry to continue along its discharge route. So, for example, the strike face 577′ of the seal 501 and corresponding seat surface 597′ may be at inclines of anywhere between 5° and 35° as opposed to a likely vertical 90° and horizontal 180° axes which may be employed at the embodiment of the seal 501 depicted in FIG. 5A.

Referring now to FIG. 6, an overview depiction of an oilfield 601 is shown employing the pump 110 of FIG. 1 in oilfield operations. The pump 110 incorporates an embodiment of a valve and seal of FIGS. 2-5A and 5B therein. Further, multiple added positive displacement pumps 600 are also utilized along with the pump 110 described above. In the embodiment shown, all of these pumps 110, 600 are a part of a hydraulic fracturing system. These pumps 110, 600 may operate at between about 700 and about 2,000 hydraulic horsepower to propel an abrasive fluid 610 into a well 625. The abrasive fluid 610 contains a proppant such as sand, ceramic material or bauxite for disbursing beyond the well 625 and into fracturable rock 615 for the promotion of hydrocarbon recovery therefrom.

In addition to pumps 110, 600, other equipment may be directly or indirectly coupled to the well head 650 for the operation. This may include a manifold 675 for fluid communication between the pumps 110, 600. A blender 690 and other equipment may also be present. In total, for such a hydraulic fracturing operation, each pump 110, 600 may generate between about 2,000 and about 10,000 PSI or more. Thus, as valves 100, 100′, 300, 400, 500 strike seats 180, 185 within each pump 110, 600, an extreme amount of stress is concentrated at each valve-seat interface as described hereinabove. Nevertheless, with added reference to FIGS. 1-5A and 5B, the rate of deterioration of valve seals 101, 101′, 301, 401, 501, 502 architecture for each assembly 110, 600 may be dramatically reduced through use of the architecture detailed hereinabove. Indeed, the useful life of such seals may be extended to the point where added labor and equipment costs devoted to regular seal change-out for operations such as those depicted here may be substantially eliminated altogether.

Embodiments detailed hereinabove provide valve configurations and seals that allow for substantial cost reductions during multi-pump operations. Specifically, depending on the period of ongoing operations, use of such valve and seal arrangements may reduce if not eliminate the need to periodically take pumps offline during use for sake of seal replacement. As a result, manpower requirements may be reduced as well as the substantial cost of having several spare million dollar pumps sitting around unused for the majority of operations. Furthermore, this is achieved in a reliable manner that does not require the use of other sophisticated seal monitoring equipment and associated expenses. Through the valve and seal configurations detailed herein, pumps may remain reliably online for greater periods, potentially even for the duration of a standard stimulation job, without the requirement of such added costly measures.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A valve for a positive displacement pump, the valve comprising:
a stationary valve seat adjacent a chamber for pumping fluid therethrough during operating of the pump;
a reciprocating valve head opposite the chamber configured to intermittently engage the seat with a metal strike face thereof;
an elastomeric seal configured to engage the seat in conjunction with the strike face engagement thereof, the engagement of the elastomeric seal with the seat sealing the fluid chamber; and
a lateral receiving support of the valve head for at least partially retaining the seal at a lower surface thereof, the strike face of the valve head including a shielding sidewall for isolating the seal from differential pressure at a discharge side of the valve.

2. The valve of claim 1 wherein the seal comprises a seal strike face at a given axis different from the metal strike face of the valve head to support the isolating of the seal from the differential pressure.

3. The valve of claim 1 wherein the seal further comprises an axial tail for sealably extending into the chamber for a time prior to the engaging of the metal strike face and the seal with the seat.

4. The valve of claim 3 wherein the seal comprises a seal strike face for the engaging with the seat.

5. The valve of claim 4 wherein the distance is selected to ensure the time prior to the engaging is no more than about 0.3 seconds during the operating of the pump.

6. The valve of claim 1 wherein the receiving support is a horizontal flange configured to extend to within a predetermined clearance of a sidewall of the chamber defined by the seat, the clearance substantially commensurate with that of a layer of an abrasive constituent within the fluid.

7. The valve of claim 6 wherein the horizontal flange extends into the chamber for a time prior to the engaging of the metal strike face and the seal with the seat.

8. The valve of claim 7 wherein the extending of the flange into the chamber is occlusive in a non-sealing manner.

9. The valve of claim 6 wherein the constituent is a proppant for a slurry of the fluid suitable for a stimulation application supported by the pumping.

10. The valve of claim 9 wherein the clearance is less than about 0.03 inches.

11. A valve for a positive displacement pump, the valve comprising:
a stationary valve seat adjacent a chamber for pumping a fluid therethrough;
a reciprocating valve head opposite the chamber for configured to intermittently engage the seat with a metal strike face thereof; and
an elastomeric seal configured to engage with the seat in conjunction with the strike face engagement thereof, wherein the engagement of the elastomeric seal with the seat seals the fluid chamber, and wherein the seat and the seal meet at a non-linear interfacing therebetween to enhance surface area contact therebetween during the engagement thereof.

12. The valve of claim 11 wherein the seal is positioned at a discharge side of the valve and the metal strike face of the valve head is positioned at a chamber side of the valve.

13. The valve of claim 12 wherein the metal strike face of the valve head is defined by a support base below the seal.

14. The valve of claim 13 wherein the elastomeric seal is left exposed to differential pressure and structurally reinforced by the support base when the valve is engaged with the seat.

15. The valve of claim 13 wherein the support base substantially occludes the chamber during the engaging of the valve at the seat to enhance the structural reinforcing of the seal.

16. A valve for a positive displacement pump, the valve comprising:
a stationary valve seat adjacent a chamber for pumping a fluid therethrough, the valve seat having discrete first and second portions at different axes from one another;
a reciprocating valve head opposite the chamber for intermittently engaging the first portion of the valve seat with a metal strike face thereof; and
an elastomeric seal configured to engage the second portion of the valve seat in conjunction with the strike face engagement of the first portion of the valve seat, wherein the engagement of the elastomeric seal with the second portion of the seat seals the fluid chamber.

17. The valve of claim 16 wherein the seal it at the discharge side of the valve and the metal strike face of the valve head is at a chamber side of the valve.

18. The valve of claim 16 wherein the second portion of the valve seat is substantially horizontal, the seal comprising a substantially horizontal strike face for engagement with second portion.

19. The valve of claim 18 wherein the seal further comprises a substantially vertical sealing face for sealing the chamber at another location of the seat in advance of the engaging between the seat and the strike faces of the seal and valve head.

20. The valve of claim 16 wherein the first and second portions of the valve seat are tapered toward one another to promote flow of the fluid from the channel to the discharge side of the valve in advance of the engagement.
